(19) United States
(12) Patent Application Publication
(10) Pub. No.: US 2026/0065412 A1
(43) Pub. Date: Mar. 5, 2026

(54) INFORMATION PROCESSING APPARATUS AND NON-TRANSITORY COMPUTER-READABLE STORAGE MEDIUM

(71) Applicant: CANON KABUSHIKI KAISHA, Tokyo (JP)

(72) Inventor: Toru SUNEYA, Kanagawa (JP)

(21) Appl. No.: 19/307,343

(22) Filed: Aug. 22, 2025

(30) Foreign Application Priority Data
Sep. 2, 2024 (JP) 2024-150877
May 9, 2025 (JP) 2025-078880

(51) Int. Cl. G06T 1/60

(52) U.S. Cl. CPC G06T 1/60; G06T 2200/04

(57) ABSTRACT

An information processing apparatus comprises a storage control unit configured to cause a memory to store the three-dimensional data and metadata corresponding to the three-dimensional data in a file in a predefined format, the storage control unit causing the memory to store, in the file, a priority level to display, for each object included in the three-dimensional data, or for at least some of those objects.

### BACKGROUND

### Field of the Technology

The present disclosure relates to information processing technology.

### Description of the Related Art

As a method of generating three-dimensional (3D) data, a method of generating 3D data using computer graphics has been conventionally known. Recently, however, there are methods of obtaining 3D data by scanning the shapes and textures of objects, such as actual objects and people, using dedicated apparatuses, studios, and the like.

In recent years, there has been a movement to use 3D data obtained in this way for automated driving, driving support, and the like or as data for free viewpoint video to be displayed on a display device such as a head-mounted display.

Meanwhile, since 3D data is generally large in data volume, standardization of standards for encoding 3D data and file format standards for storing encoded 3D data is underway at Moving Picture Experts Group (MPEG) under the umbrella of the International Organization for Standardization (ISO) and the International Electrotechnical Commission (IEC).

3D data is generally handled in data formats such as point cloud data and 3D mesh data, but at MPEG, for example, ISO/IEC 23090-5 Visual Volumetric Video-based Coding (V3C) and Video-based Point Cloud Compression (V-PCC) (hereinafter, referred to as V3C/V-PCC), which is a standard for encoding using a video codec or the like, has been standardized, as an example of a standard for encoding point cloud data, and ISO/IEC 23090-10 Carriage of visual volumetric video-based coding data (hereinafter, referred to as Carriage of V3C) has been standardized as a standard for storing point cloud data encoded by the above standard in a file.

Incidentally, in the case of using the above 3D data as data for free viewpoint video, the rendering processing load in the display of 3D data may become an issue. When a team sport, such as basketball or soccer, for example, is viewed in free viewpoint video, 3D data of a plurality of players scanned during a match must be rendered simultaneously. Furthermore, 3D data obtained by scanning a person tends to require high-quality data with high-resolution shape data and detailed texture, and since higher-quality data is larger in data volume, the processing load at the time of rendering also tends to be larger.

Therefore, a method of reducing the load in processing for displaying 3D data is required.

### SUMMARY

The present disclosure provides a technique for favorably performing processing for displaying 3D data and reducing processing load.

According to the first aspect of the present disclosure, there is provided an information processing apparatus comprising: a storage control unit configured to cause a memory to store the three-dimensional data and metadata corresponding to the three-dimensional data in a file in a predefined format, the storage control unit causing the memory to store, in the file, a priority level to display, for each object included in the three-dimensional data, or for at least some of those objects.

According to the second aspect of the present disclosure, there is provided an information processing apparatus comprising: an obtaining unit configured to obtain, from a file in which three-dimensional data and metadata corresponding to the three-dimensional data are stored in a predefined format, a priority level to display, which is stored for each object included in the three-dimensional data, or for at least some of those objects; and a control unit configured to control reproduction of the three-dimensional data based on the priority level.

According to the third aspect of the present disclosure, there is provided an information processing apparatus configured to generate metadata corresponding to three-dimensional data, the information processing apparatus comprising: an obtaining unit configured to obtain three-dimensional data, the three-dimensional data obtained by the obtaining unit including a plurality of objects; and a setting unit configured to set a priority level to display, for each of the objects included in the three-dimensional data, or for at least some of the objects, the set priority level being generated as metadata.

According to the fourth aspect of the present disclosure, there is provided a non-transitory computer-readable storage medium storing instructions of a computer program for causing a computer to function as each unit of the information processing apparatus.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a hardware configuration of an information processing apparatus 100.

FIG. 2 is a flowchart of processing that is performed by the information processing apparatus 100.

FIG. 3 is a diagram illustrating an example of a configuration of a 3D media file.

FIG. 4 is a diagram illustrating an example of a metadata description for setting a priority level for an object.

FIG. 5A is a diagram for explaining a case where objects are viewed from a particular viewpoint.

FIG. 5B is a diagram for explaining a case where objects are viewed from a particular viewpoint.

FIG. 5C is a diagram for explaining a case where objects are viewed from a particular viewpoint.

FIG. 6A is a diagram illustrating an example of a metadata description for setting a priority level for an object in association with a viewport.

FIG. 6B is a diagram illustrating an example of a metadata description for setting a priority level for an object in association with a viewport.

FIG. 7 is a flowchart of processing that is performed by the information processing apparatus 100.

FIG. 8 is a schematic diagram illustrating a case where a portion of an object that can be divided into a plurality of sub-objects is viewed.

FIG. 9 is a schematic diagram illustrating a case where an object (divided object) that has been subdivided into tiles is viewed.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

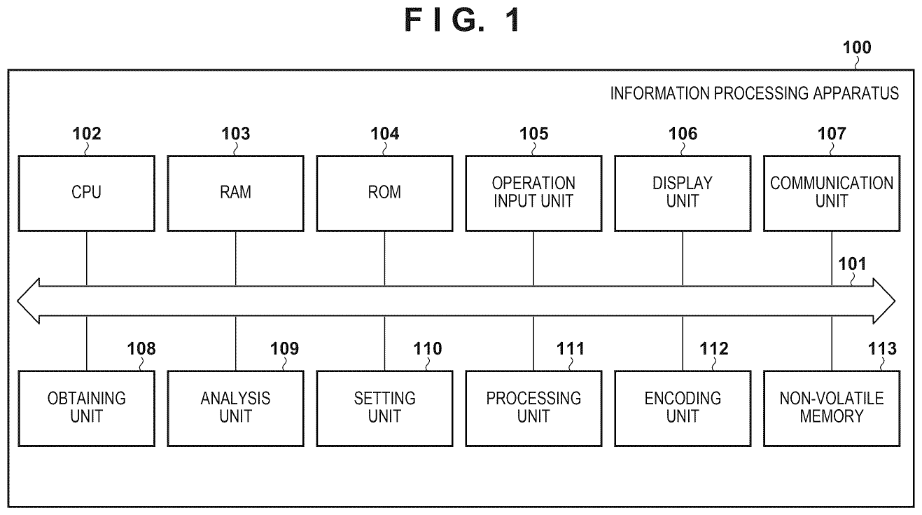

First, an example of a hardware configuration of the information processing apparatus 100 according to the present embodiment will be described with reference to a block diagram of FIG. 1. A computer apparatus, such as a personal computer (PC), a tablet terminal apparatus, or a smartphone, can be applied to the information processing apparatus 100 according to the present embodiment.

A CPU 102 executes various processes using computer programs and data stored in a RAM 103. The CPU 102 thus performs control of operation of the entire information processing apparatus 100 and executes or controls various processes described as processes to be performed by the information processing apparatus 100.

The RAM 103 includes an area for storing computer programs and data loaded from a ROM 104 and anon-volatile memory 113 and an area for storing computer programs and data received from an external apparatus via a communication unit 107. Further, the RAM 103 includes a work area that the CPU 102, an obtaining unit 108, an analysis unit 109, a setting unit 110, a processing unit 111, and an encoding unit 112 use when executing various processes. The RAM 103 can thus provide various areas as appropriate.

The ROM 104 stores setting data of the information processing apparatus 100, computer programs and data related to startup of the information processing apparatus 100, computer programs and data related to a basic operation of the information processing apparatus 100, and the like.

An operation input unit 105 is a user interface, such as a keyboard, a mouse, and a touch panel, and can input various kinds of instructions and information to the information processing apparatus 100 by being operated by a user.

A display unit 106 includes a liquid crystal screen or a touch panel screen and can display a result of processing by the CPU 102 by using images, characters, and the like. The display unit 106 may be a projection device such as a projector for projecting images and characters.

Further, a configuration may be such that the display unit 106 is a touch panel and the operation input unit 105 includes a touch panel sensor. In that case, upon detecting an operation input to the user interface screen displayed on the display unit 106, the operation input unit 105 outputs a control signal indicating that to the CPU 102.

The communication unit 107 performs data communication with an external apparatus through a network, such as a LAN or the Internet. For example, the communication unit 107 is PHY and MAC (transmission media control processing) of Ethernet® of a wired LAN. Further, when the information processing apparatus 100 can be connected to a wireless LAN, the communication unit 107 includes a controller, an RF circuit, and an antenna for executing wireless LAN control such as IEEE 802.11a/b/g/n/ac.

Respective operations of the obtaining unit 108, the analysis unit 109, the setting unit 110, the processing unit 111, and the encoding unit 112 will be described later. In the present embodiment, a case where the obtaining unit 108, the analysis unit 109, the setting unit 110, the processing unit 111, and the encoding unit 112 are all implemented by hardware will be described. The obtaining unit 108, the analysis unit 109, the setting unit 110, the processing unit 111, and the encoding unit 112 may each be a separate piece of hardware, or two or more function units may be implemented by one piece of hardware. Further, one or more of the obtaining unit 108, the analysis unit 109, the setting unit 110, the processing unit 111, and the encoding unit 112 may be implemented by software (a computer program). In that case, the CPU 102 executes a computer program corresponding to that function unit to realize a function corresponding to that function unit.

The non-volatile memory 113 is, for example, a flash memory, such as an SD card or an SSD, or a magnetic recording apparatus, such as a hard disk drive. The non-volatile memory 113 stores an operating system (OS), computer programs and data for causing the CPU 102 to execute or control various processes described as processes to be performed by the information processing apparatus 100, and the like.

The CPU 102, the RAM 103, the ROM 104, the operation input unit 105, the display unit 106, the communication unit 107, the obtaining unit 108, the analysis unit 109, the setting unit 110, the processing unit 111, the encoding unit 112, and the non-volatile memory 113 are all connected to a system bus 101.

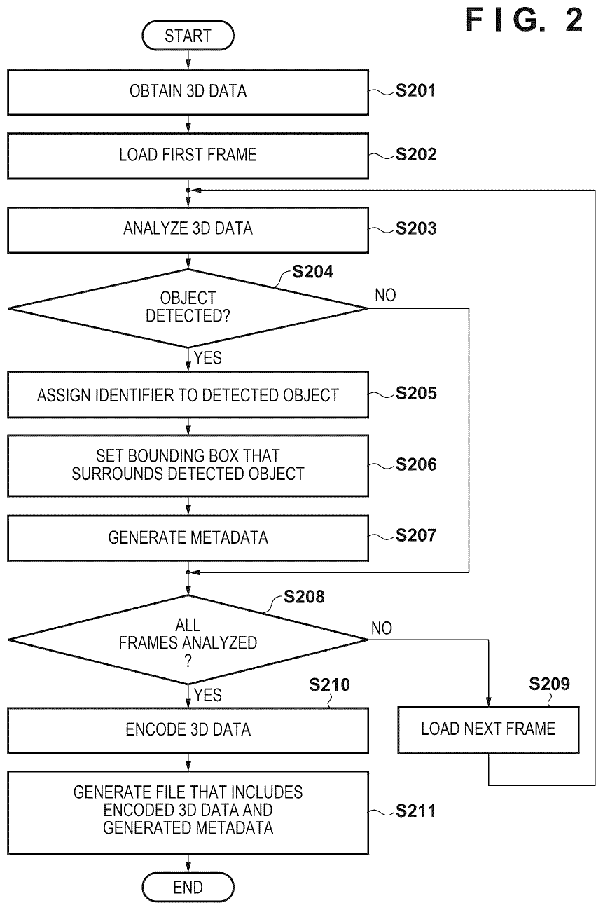

Next, a series of processes for generating a 3D media file by detecting an object included in three-dimensional data (3D data) and storing metadata associated with the detected object and encoded data obtained by encoding the three-dimensional data in a file in a predetermined format will be described according to the flowchart of FIG. 2.

In step S201, the obtaining unit 108 obtains 3D data that includes a point cloud or a 3D mesh that defines an object. A method for the obtaining unit 108 to obtain 3D data is not limited to a particular method. For example, the obtaining unit 108 may obtain 3D data received by the communication unit 107 from an external apparatus or may obtain 3D data stored in advance in the non-volatile memory 113. Since 3D data is dynamic data in which contents may change along the time axis and is generated for each frame, in step S201 the obtaining unit 108 obtains 3D data of a plurality of frames.

In step S202, the obtaining unit 108 loads (stores) 3D data of the first frame into the RAM 103 among 3D data for each frame obtained in step S201. As long as the processing of steps S203 to S209 can be performed on 3D data of each frame of the plurality of frames, the method or configuration for obtaining 3D data of each frame into the RAM 103 is not limited to a particular method or configuration.

In step S203, the analysis unit 109 analyzes 3D data of the frame (hereinafter, referred to as the target frame) stored in the RAM 103 and determines whether the 3D data includes an object. The object is not limited to any particular type of object. The analysis unit 109 may use, for example, AI technology such as machine learning to determine whether an object is included in 3D data.

As a result of such determination, if an object is included in the 3D data of the target frame (if an object is detected in the 3D data of the target frame), the processing proceeds to step S205 via step S204.

Meanwhile, if an object is not included in the 3D data of the target frame (if an object is not detected in the 3D data of the target frame), the processing proceeds to step S208 via step S204.

In step S205, the processing unit 111 assigns a unique identifier to each object included in the 3D data of the target frame. Each object included in the 3D data is assigned a different identifier from each other, and the same identifier is assigned to the same object between frames.

In step S206, the analysis unit 109 sets a bounding box that surrounds the object for each object included in the 3D data of the target frame. “Setting a bounding box” means setting the position (three-dimensional coordinates) and size (vertical, horizontal, and height) of a bounding box in three-dimensional space. For example, the analysis unit 109 sets the center coordinates of the object as the position of the bounding box, sets a region that expands, from that position as the center, in the directions of three axes, X, Y, and Z, so as to surround the object as the bounding box, and sets the lengths of the bounding box in respective X, Y, and Z axis directions as the size of the bounding box. The analysis unit 109 may further define rotational angles of the bounding box with respect to the three axes, X, Y, and Z. Thus, the bounding box may not necessarily be constituted by planes perpendicular to the three axes, X, Y, and Z. Further, the bounding box need not be a region that includes the entire object and may be an area in which a portion of the object is enclosed.

In step S207, the setting unit 110 sets a priority level to display for each object included in the 3D data of the target frame or for bounding boxes of respective objects. The method of setting a priority level for an object or for a bounding box is not limited to a particular method, and for example, a priority level inputted by the user by operating the operation input unit 105 may be set.

In the present embodiment, the priority level indicates either a level of priority or a level of recommendation as an example. Generally, the target of priority is set to a higher level of priority. In addition, the content (object) creator's intent is prioritized, and a higher level of recommendation is set for content with a higher level of importance as content. The priority level is not limited to being set in step S207 and may be set prior to step S207.

Then, the processing unit 111 performs data processing that conforms to the standard of a prescribed file format on the identifier assigned to the object, the position and size of the bounding box, and the priority level set for the object or bounding box, and generates “metadata” that includes these pieces of information and is “in a form conforming to the specification of the prescribed file format”. This metadata is metadata related to 3D data obtained in step S201.

In step S208, the analysis unit 109 determines whether 3D data of all the frames has been analyzed. As a result of this determination, if 3D data of all the frames has been analyzed, the processing advances to step S210, and if there is 3D data of a frame that has not yet been analyzed, the processing advances to step S209.

In step S209, the obtaining unit 108 loads (stores) 3D data of a frame after the target frame into the RAM 103 among 3D data for each frame obtained in step S201.

In step S210, the encoding unit 112 encodes 3D data of all the frames by using a method that conforms to an encoding standard such as V3C/V-PCC and thereby generates the encoded data of the 3D data.

In step S211, the processing unit 111 stores the encoded data generated in step S210 and the metadata generated in step S207 in a file that conforms to a file format standard such as Carriage of V3C (performs storage control). Then, the processing unit 111 outputs such a file as a 3D media file. The output destination of the 3D media file is not limited to a particular output destination, and for example, the processing unit 111 may output the 3D media file to the non-volatile memory 113 or may transmit it to an external apparatus via the communication unit 107.

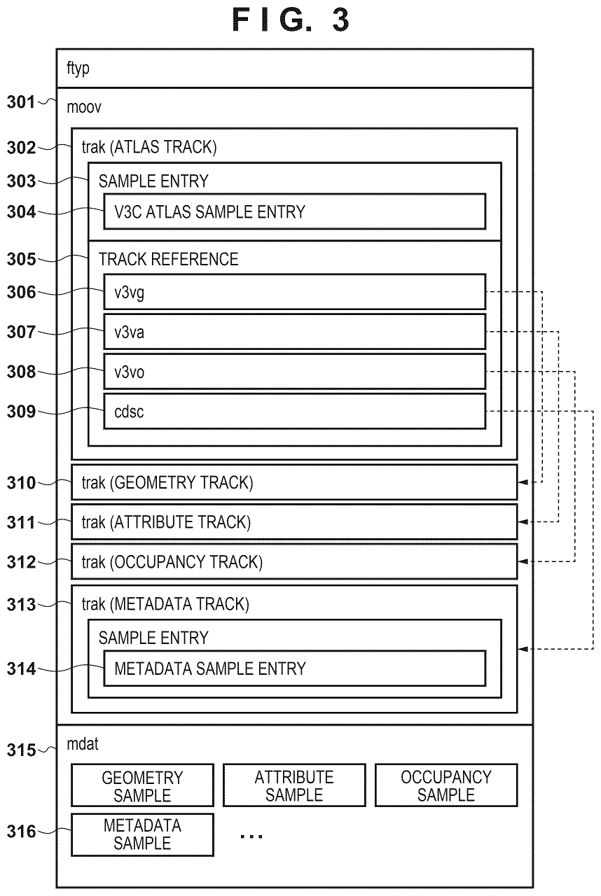

Next, an example of a configuration of a 3D media file generated by the information processing apparatus 100 will be described with reference to FIG. 3. A file format described in FIG. 3 will be described based on ISO Base Media File Format (hereafter referred to as ISOBMFF), which is a basic specification of media files standardized by MPEG.

In FIG. 3, moov 301 includes an atlas track 302, a geometry track 310, an attribute track 311, an occupancy track 312, and a metadata track 313.

The atlas track 302 stores, for example, metadata related to a region in which encoded data (encoded 3D data) stored in a 3D media file exists, the configuration information of the encoded data, and the like.

The geometry track 310 is a track for managing coordinate information indicating the shape of an object, and the attribute track 311 is a track for managing attribute information including information such as the surface color and light reflectance of the object. The occupancy track 312 is a track for managing information identifying a three-dimensional space in which the object exists, and the metadata track 313 is a track in which attribute information and the like of 3D data that changes along the time axis can be stored.

Further, these four tracks, the geometry track 310, the attribute track 311, the occupancy track 312, and the metadata track 313 are associated with the atlas track 302 by a track reference 305. v3vg 306, v3va 307, v3vo 308, and cdsc 309 included in the track reference 305 indicate the reference types of respective associated tracks.

Incidentally, FIG. 3 illustrates an example of a configuration of tracks when a point cloud defining an object is encoded in the encoding standard V3C/V-PCC, and data managed by the respective tracks, such as encoded data, is stored in mdat 315.

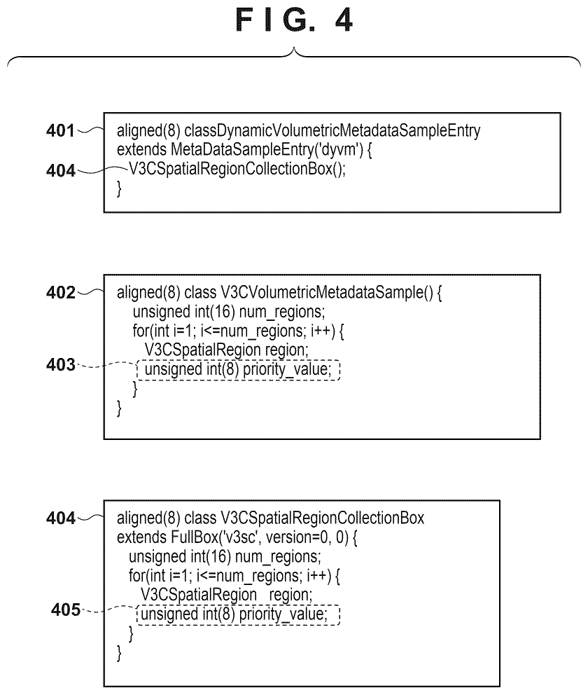

In the present embodiment, the metadata track 313 is used to store the priority level of an object or bounding box in the 3D media file as metadata associated with the object or bounding box. FIG. 4 is a diagram illustrating an example of a metadata description for setting a priority level for an object.

In FIG. 4, Dynamic VolumetricMetadataSampleEntry 401 is one of the sample entries defined in Carriage of V3C, and this sample entry can be included in the metadata track 313 as a metadata sample entry 314 of FIG. 3. In this case, a spatial region in which the 3D data transmitted by the atlas track 302 exists is considered to be a dynamic region.

According to Carriage of V3C, when scene object information indicating the state of object an in 3D space changes over time, V3CVolumetricMetadataSample 402 can indicate the change in position and size of the bounding box surrounding the detected object. This sample is stored in mdat 315 as a metadata sample 316 of FIG. 3, and when the scene object information changes, there are one or more V3CVolumetricMetadataSample 402.

Here, in the present embodiment, for example, a parameter called priority_value 403 is added to V3CVolumetricMetadataSample 402. num_regions in V3CVolumetricMetadataSample 402 indicates the number of bounding boxes surrounding detected objects, and region includes the positions and sizes of those bounding boxes, the identifiers of objects included in the bounding boxes, and the like. Therefore, the value of priority_value 403 is a numerical value representing the priority level for a respective bounding box. The value of the priority_value 403 may be defined such that, for example, 0 (zero) is the highest priority level, and the priority level decreases as the value increases.

Thus far, a case where Dynamic VolumetricMetadataSampleEntry 401 is stored as the metadata sample entry 314 in the metadata track 313 has been described. Meanwhile, a case where V3CSpatialRegionCollectionBox 404 included in Dynamic VolumetricMetadataSampleEntry 401 is directly stored as a V3C atlas sample entry 304 in a sample entry 303 of the atlas track 302 will be described.

According to Carriage of V3C, in this case, since the spatial region in which 3D data transmitted by the atlas track 302 exists is considered to be a static region, the scene object information representing the state of the object in 3D space does not change over time. Therefore, in the present embodiment, a priority level for each bounding box is defined, for example, by adding a parameter priority_value 405 to V3CSpatialRegionCollectionBox 404.

Thus, by defining a priority level for each bounding box surrounding a detected object, it becomes possible, at the time of processing for reproducing objects, to display them starting with the highest priority level in accordance with, for example, the processing capability of the apparatus that performs the reproduction processing.

In addition, when there is an object to be excluded from the reproduction processing, it is possible to intend to exclude it from being a target of reproduction processing, for example, by setting the priority_value 403 or priority_value 405 to a value that corresponds to the lowest priority level.

In the description of the file configuration with reference to FIG. 3, a multi-track configuration in which a plurality of tracks (the atlas track 302, the geometry track 310, the attribute track 311, the occupancy track 312, and the metadata track 313) are included in moov 301, has been described. However, according to Carriage of V3C, a single-track configuration in which a plurality of tracks that manage encoded 3D data are combined into one except for the metadata track 313, is also possible.

In a single-track configuration, only one track called a V3C bitstream track, in which the atlas track 302, the geometry track 310, the attribute track 311 and the occupancy track 312 are combined into one, is generated, and in the sample entry in the V3C bitstream track, a plurality of different samples are defined, and different types of samples are managed by treating a combined sample in which different types of samples with the same presentation times are combined as one sample in the V3C bitstream track.

In the case of such a single-track configuration, it can replace the multi-track configuration described above by associating the V3C bitstream track with the metadata track using a cdsc-type track reference.

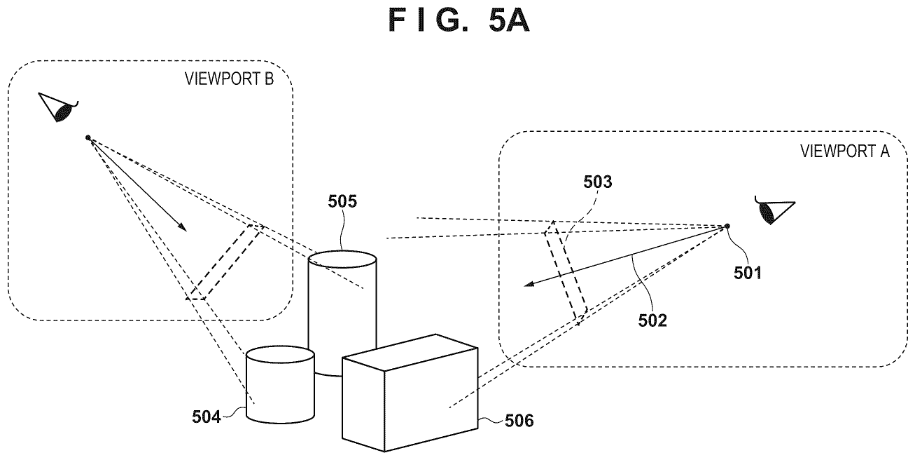

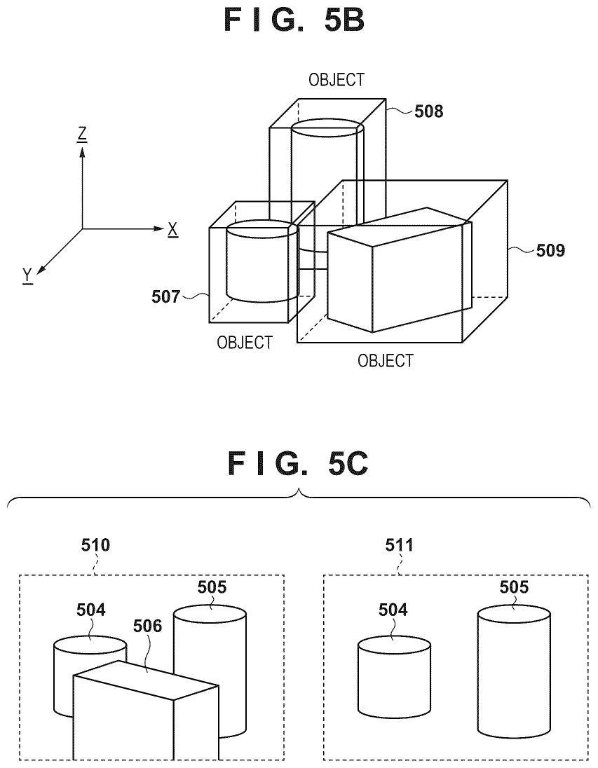

Next, a case where objects are viewed from a particular viewpoint will be described with reference to FIGS. 5A to 5C. FIG. 5A illustrates a state in which an object group (objects 504, 505, and 506) defined by 3D data are viewed from the viewpoint 501 in a gaze direction 502 at a viewing angle 503. Hereinafter, a combination of the viewpoint 501, the gaze direction 502, and the viewing angle 503 will be referred to as viewport A.

The above three objects, which are viewing targets in viewport A, are objects detected in 3D data by the analysis processing of step S203. Further, bounding boxes 507 to 509 of FIG. 5B are bounding boxes respectively set for objects 504 to 506 in step S206.

Here, when the objects 504 and 505 are important objects as viewing targets while the object 506 is unimportant as a viewing target, the objects 504 and 505, which are important as viewing targets, may be blocked by the unimportant object 506 as illustrated in a viewing angle 510 of FIG. 5C, for example. That is, when viewing viewport A, it is desirable to be able to view the objects 504 and 505, unobstructed by the object 506, as with viewing angle 511, by eliminating the object 506, which interferes with the viewing thereof.

Meanwhile, in FIG. 5A, when viewing the above object group in viewport B, which has a different viewpoint, gaze direction, and viewing angle, and the like from viewport A, the object 506 does not interfere with the viewing and thus need not be eliminated. That is, when viewing the same object group in different viewports, even if it is at the same timing, objects recommended for viewing and objects not recommended for viewing may vary depending on the viewport.

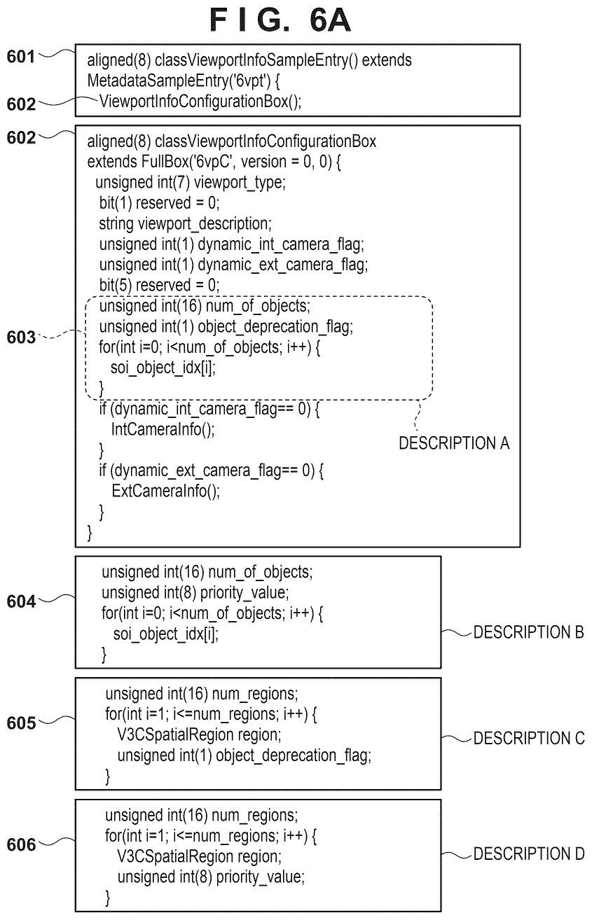

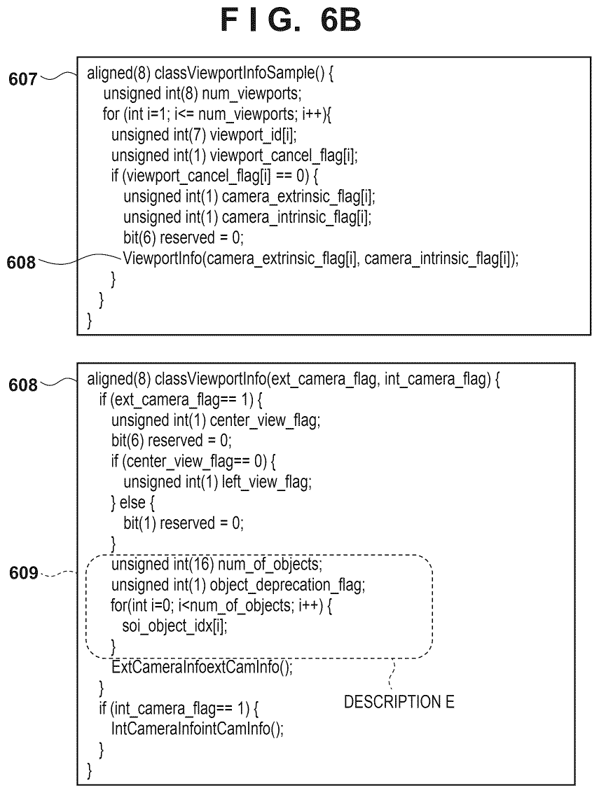

Therefore, a method of associating a viewport with the priority level of an object will be described with reference to FIG. 6A and FIG. 6B. FIG. 6A and FIG. 6B are a diagram illustrating an example of a metadata description for setting a priority level for an object in association with a viewport. FIG. 6A and FIG. 6B illustrate an example of a metadata description for setting a priority level of an object in association with viewport information, which includes information on a viewpoint, a gaze direction, and a viewing angle in space based on 3D data.

ViewportInfoSampleEntry 601 is one of the sample entries defined in Carriage of V3C, and this sample entry can be included in the metadata track 313 as the metadata sample entry 314 of FIG. 3. The configuration described with reference to FIG. 4 can coexist with the configuration to be described hereafter, but in that case, the metadata track 313 needs to be a different track.

In the present embodiment, a description A 603 is added to ViewportInfoConfigurationBox 602 included in ViewportInfoSampleEntry 601. The description A 603 defines recommendation/non-recommendation for each object.

num_of_objects indicates the number of objects for which recommendation/non-recommendation is designated among objects included in the viewport.

object_deprecation_flag is a flag indicating whether an object is a recommended object or an unrecommended object. For example, when object_deprecation_flag is 0, it means that objects with identifiers that follow are recommended objects. Meanwhile, when object_deprecation_flag is 1, it means that objects with identifiers that follow are unrecommended objects.

soi_object_idx[i] is intended to be an identifier for each object included in scene object information Supplemental Enhancement Information (SEI) defined in V3C/V-PCC. That is, by using object_deprecation_flag, it is not necessary to describe the identifiers of all the objects, especially when there are many objects, for example, so the amount of description can be reduced. The description method described here is only one example, and information by which recommendation/non-recommendation of objects can be identified need only be included.

A level of priority for each object can be defined when a description B 604 is added to ViewportInfoConfigurationBox 602 instead of the description A 603. priority_value of the description B 604 is a parameter indicating a level of priority.

Further, when defining recommendation/non-recommendation for each bounding box surrounding an object, it can be realized by adding a description such as a description C 605 to ViewportInfoConfigurationBox 602.

Further, when defining a level of priority for each bounding box surrounding an object, it can be realized by adding a description such as a description D 606 to ViewportInfoConfigurationBox 602.

Further, according to Carriage of V3C, when the viewport changes dynamically, viewport information can be defined as a sample of the metadata track 313. ViewportInfoSample 607 is a sample that stores viewport information defined in Carriage of V3C, and the viewport information is included in ViewportInfo 608.

In the present embodiment, recommendation/non-recommendation for each object can be indicated by adding a description E 609 to ViewportInfo 608. The roles of the parameters described in the description E 609 are as described in the description A. Further, by replacing the description E 609 with the description B 604, the description C 605, and the description D 606, a level of priority for each object, recommendation/non-recommendation for each bounding box surrounding an object, and a level of priority for each bounding box surrounding an object can respectively be defined.

As another method of defining a level of priority for an object or for a bounding box surrounding an object, a method in which, when identifiers of objects or bounding boxes surrounding an object are listed, they are listed in order of the level of priority (in descending or ascending order) is also possible. Further, at this time, an object or bounding box whose identifier is not included in the list may be implicitly defined as having the lowest (or highest) level of priority. This is similar for the level of recommendation. For example, when an object not listed is not to be displayed due to having the lowest priority level, there is no need to re-identify an object included in the viewport. Since only the listed objects need to be displayed in accordance with designated priority levels, the processing load at the time of display can be reduced, especially when there are many objects.

Further, in a free viewpoint video, generally the viewport changes dynamically over time, but as described with reference to FIG. 6A and FIG. 6B, the viewport information can be described as a sample of the metadata track 313. That is, by generating a timed metadata track in which viewport information is stored, it is possible to define changes in the viewport over time. Therefore, if there are a plurality of viewports, a timed metadata track, in which viewport information corresponding to the number of viewports is stored, may be generated.

The timed metadata track in which viewport information is stored may be used to track a particular object. For example, in sports content in which a plurality of players play simultaneously, a viewport focused on a particular player may be defined. In such cases, soi_object_idx[i] or region defined in V3CSpatialRegion may be set to track a particular player.

Regarding ViewportInfoSample 607, since viewports corresponding to the value of num_viewports can be defined, a viewport may be defined for each particular player, but in sport content streaming or the like, for example, if tracks are divided for each particular player of interest, a viewing user can preferentially view a particular player by receiving only the track in which viewport information for the particular player of interest is stored. Furthermore, it is possible to preferentially reproduce a particular player by setting a priority level indicating a high level of priority for a particular player and setting a priority level indicating a lower level of priority than the particular player for other players and objects.

Further, in order to facilitate the control of display/non-display of each object, encoded 3D data for each object may be made to be independent encoded 3D data. When storing a plurality of pieces of independent encoded data in a file, in the file configuration described with reference to FIG. 3, tracks that manage encoded 3D data are constituted by five tracks including the atlas track 302 and the geometry track 310, the attribute track 311, the occupancy track 312, and the metadata track 313, which are associated with and the atlas track 302, but these five tracks may be generated for each object in order to manage independent encoded data for each object.

When a plurality of objects constituted by independent encoded 3D data are displayed in the same 3D space, coordinate origin that serves as a reference in 3D space, axial directions, tilt, scale, and the like need to match. Generally, encoded 3D data sets reference coordinates in 3D space, and can represent the position, shape, movement, and the like of an object with position information in those coordinates. Therefore, as a simple method of matching the coordinate origin or the like, by capturing a plurality of objects in an environment in which the same coordinate origin is set in advance, it is possible to make objects have the same coordinate origin and scale even if they are independent as encoded 3D data. This is possible in a studio for 3D capture, or with a 3D capture system or the like that is installed in a stadium or the like and mainly captures players.

Meanwhile, when objects captured in different environments, CG objects created by a computer, and the like are displayed in the same 3D space, it is necessary to define global coordinates or the like that are shared among a plurality of tracks that manage encoded 3D data to be displayed in the same 3D space. That is, it can be realized by generating or obtaining, for each object, the object's offset relative to the origin and axial directions, tilt, scale information, and the like in the shared global coordinates and storing them in, for example, a metadata track or the like of the object.

In this way, when each piece of independent encoded 3D data is stored as a separate track for each object, the level of priority or the level of recommendation can be defined at the track level, not at the object level. That is, the level of priority or the level of recommendation may be set for each track ID, which is identification information of the track. However, as described above, when there are a plurality of tracks that manage the same encoded 3D data, such as in the example of FIG. 3, the atlas track 302, which stores the reference information of each track, may be set as a representative track, and the track ID of the representative track and the level of priority or the level of recommendation may be set.

Incidentally, viewport information is expected to be used to define the viewing point recommended by the content creator when content is viewed as a free viewpoint video and may be used as default viewing coordinates when content is viewed on a head-mounted display, especially when viewing coordinates are not designated on the head-mounted display side. In such a case, if there are a plurality of timed metadata tracks in which viewport information is stored, it is unknown which track is recommended or has a high level of recommendation.

Therefore, the simplest method of determination is a method of implicitly defining that the smaller the numerical value of the track ID of a timed metadata track in which viewport information is stored, the higher or lower level of recommendation. Alternatively, it can be realized by a method in which a group of timed metadata tracks in which viewport information is stored is created as an EntityToGroupBox, for example, in a track level meta box and information by which the level of recommendation or the level of priority can be identified is described therein.

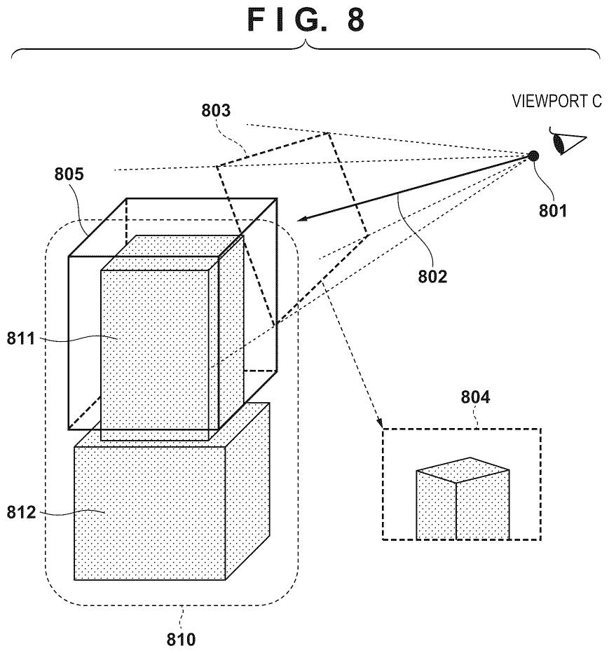

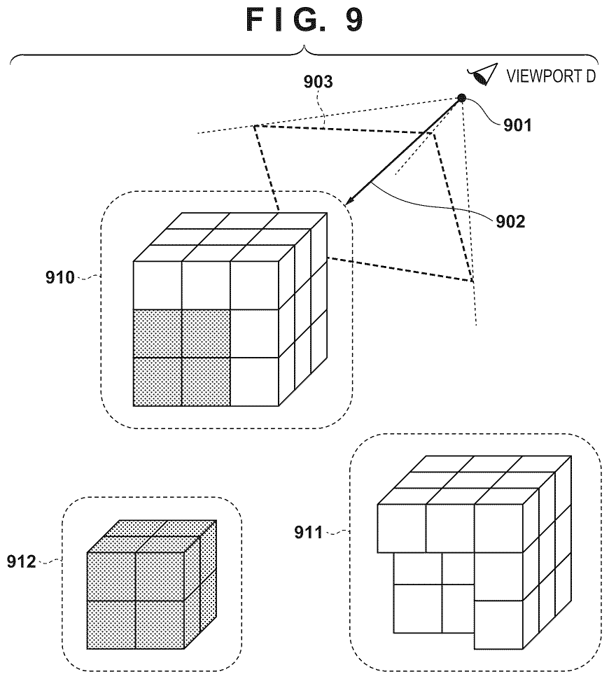

Next, a method of configuring an object and a bounding box will be described in more detail with reference to FIG. 8. FIG. 8 is a schematic diagram illustrating a case where a portion of an object that can be divided into a plurality of sub-objects is viewed.

In FIG. 8, viewport C includes a viewpoint 801, a gaze direction 802, and a viewing angle 803, and a viewing angle 804 indicates an example of a video that can be viewed at the viewing angle 803. Further, an object 810 is constituted by a sub-object 811 and a sub-object 812, both of which can be individually decoded and rendered.

Here, only the sub-object 811 is included in the viewing angle of viewport C illustrated in FIG. 8. That is, since the data of an object necessary for viewing is only the sub-object 811, a bounding box 805 defines only a region that includes only the sub-object 811. Thus, by making it possible to obtain only the data of the sub-object 811, it is possible to avoid obtaining unnecessary data not used for viewing.

Therefore, in order to make it possible to obtain only the data of the part necessary for viewing, it is desirable to be able to divide the object into a plurality of regions and encode the plurality of regions. For example, in V3C/V-PCC, which is one of the point cloud encoding standards, a function for dividing an object into tiles and encoding the tiles is supported in order to improve parallel processing and spatial random access, and each divided tile can be decoded independently. Here, “divided into tiles” refers to a state in which an object is divided into a plurality of regions in 3D space in which the object exists, in a plane that is horizontal or vertical to a coordinate axis, and a method in which the object is divided into tiles and encoded in this way so as to be independently decodable will be referred to as tile encoding below.

In FIG. 8, by dividing the sub-object 811 and the sub-object 812 constituting the object 810 into respective independent tiles and encoding the tiles, the sub-object 812, which is not included in the viewing angle 803 of viewport C, does not need processing such as obtaining, decoding, and rendering of encoded data.

Next, a case where an object is further subdivided and encoded as tiles will be described with reference to FIG. 9. FIG. 9 is a schematic diagram illustrating a case where an object that has been subdivided into tiles (divided object) is viewed.

In FIG. 9, viewport D includes a viewpoint 901, a gaze direction 902, and a viewing angle 903 and an object 910 is being viewed from slightly above. The object 910 is divided into a plurality of regions in 3D space, and each divided region is encoded as a tile. Here, tiles necessary for viewing viewport D are tiles that are included in the viewing angle, even partially, but tiles positioned in an occlusion region (blind spot), which does not include data to be rendered, need not be obtained. That is, even if included in the viewing angle, the encoded data of an occlusion region not used for rendering is unnecessary for viewing.

Here, FIG. 9 illustrates a state in which the object 910 is divided into tiles obtained by dividing each side into three segments and each divided tile is encoded, and a sub-object 911 is a set of tiles necessary for viewing at the viewing angle 903 of viewport D, while a sub-object 912 is a set of tiles included in an occlusion region of viewport D. Thus, regarding the object 910, all the tiles are included in the viewing angle 903 of viewport D, but only the sub-object 911 is necessary for rendering, and the sub-object 912 need not be obtained.

In this way, by using an encoding mechanism in which an object is subdivided and can be partially decoded, such as tile encoding, it is possible to omit the data of a region not included in the viewing angle when viewing a particular viewport, as well as the data of an occlusion region, and it is possible to efficiently process only the data necessary for viewing.

In tile encoding, generally identifiers for identifying individual tiles are assigned and included in encoded data, and this is similar for V3C/V-PCC. Here, when viewing a desired viewport, in order to obtain only the tiles corresponding to the sub-object 911 of FIG. 9, strictly speaking it is necessary to know the identifiers of the tiles comprising the sub-object 911. Therefore, it can be known by associating a list of identifiers of one or more tiles necessary for viewing (rendering) with ViewportInfoSampleEntry 601 or ViewportInfoSample 607 in which viewport information is stored, as described with reference to FIG. 6A and FIG. 6B.

Further, recommendation/non-recommendation or priority level information, such as the description A 603 or the description B 604 of FIG. 6A, may be designated for each sub-object. By explicitly designating sub-objects unnecessary for viewing, the reproduction side can easily identify which sub-objects need to be displayed at the time of display, and thus the processing load can be reduced.

Although the description of the embodiment thus far has been made with reference to V3C/V-PCC as the 3D data encoding standard, the effect does not depend on a particular encoding standard in the implementation system. That is, in addition to V3C/V-PCC, ISO/IEC 23090-9 Geometry-based Point Cloud Compression (G-PCC), which is also standardized by MPEG, or ISO/IEC 23090-29 Video-based dynamic mesh coding (V-DMC), which is a 3D mesh encoding standard, may be used. Other 3D encoding standards such as Gaussian Splat may be used.

Similarly, in the embodiment thus far, Carriage of V3C has been described as a file format standard, but the implementation system does not depend on a particular file format standard. For example, a similar storage method can be used for other storage standards that support the coding format of encoded 3D data to be stored, such as ISO/IEC 23090-18 Carriage of Geometry-based Point Cloud Compression Data, which is a standard for storing the above G-PCC encoded data.

Further, common information that does not depend on encoding standards, such as viewport information in 3D space, is defined in ISO/IEC 23090-7 Immersive media metadata and is referenced from file format standards such as Carriage of V3C and Carriage of Geometry-based Point Cloud Compression Data. That is, viewport information can also be construed as generalized information and does not depend on a particular standard.

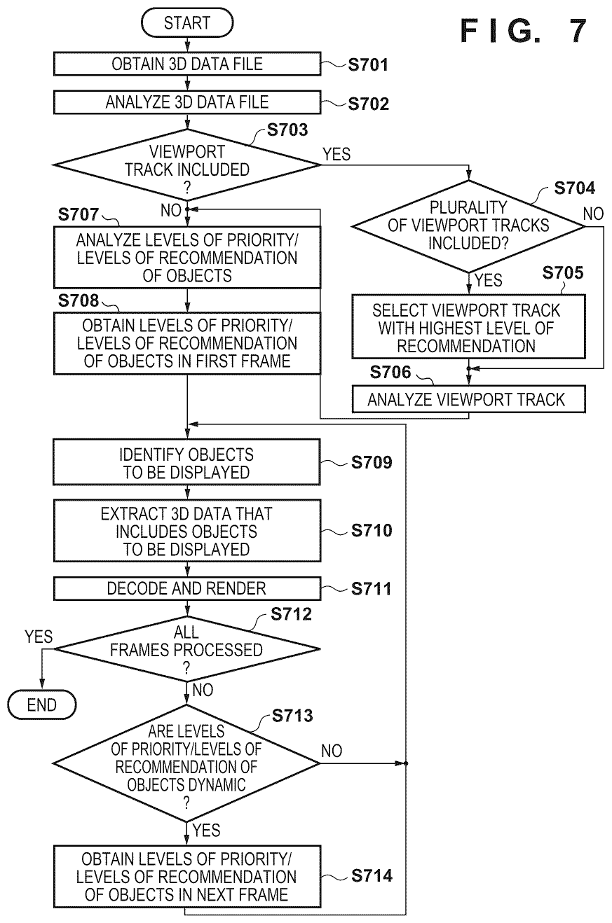

Next, processing for reproducing 3D data extracted from a 3D media file generated by the method described in the embodiment thus far will be described according to the flowchart of FIG. 7. FIG. 7 is a flowchart for explaining an example of processing for reproducing an object from a 3D media file in which 3D data is stored by using the level of priority.

In the following, a case where the information processing apparatus 100 performs processing according to the flowchart of FIG. 7 will be described, but the present invention is not limited thereto, and an apparatus other than the information processing apparatus 100 may obtain a 3D media file and perform the above reproduction processing.

In step S701, the obtaining unit 108 loads (obtains) a 3D media file stored in the non-volatile memory 113 into the RAM 103.

In step S702, the analysis unit 109 analyzes the configuration, and the like of tracks included in the 3D media file obtained in the RAM 103.

In step S703, the analysis unit 109 determines whether a track (viewport track) in which viewport information is stored is included in the 3D media file as a result of analysis in step S702.

As a result of this determination, if a viewport track is included in the 3D media file, the processing proceeds to step S704, and if a viewport track is not included in the 3D media file, the processing proceeds to step S707.

In step S704, the analysis unit 109 determines whether a plurality of viewport tracks are included in the 3D media file. As a result of this determination, if a plurality of viewport tracks are included in the 3D media file, the processing proceeds to step S705, and if a plurality of viewport tracks are not included in the 3D media file, the processing proceeds to step S706.

In step S705, the analysis unit 109 selects a viewport track with the highest level of recommendation among the plurality of viewport tracks. The level of recommendation is determined by a method defined in the various examples above, or if no level of recommendation is defined in particular, the track with the lowest numerical value for the track ID among the viewport tracks may be selected.

In step S706, the analysis unit 109 sets the viewport track selected in step S705 or a single viewport track included in the 3D media file as an analysis target and analyzes the analysis target.

In step S707, the analysis unit 109 analyzes the priority levels of objects. As described with reference to FIG. 6A and FIG. 6B and the like, when a priority level is defined not for each object but for each bounding box surrounding an object, the analysis unit 109 analyzes the priority levels of bounding boxes. Although description will be given for objects below, even if they are bounding boxes, the subsequent processing is performed in a similar manner.

In step S708, the CPU 102 obtains the priority levels of objects corresponding to the 3D data of the first frame.

In step S709, the CPU 102 identifies objects to be displayed/objects to not be displayed based on the priority levels obtained in step S708.

In step S710, the CPU 102 extracts encoded data that includes objects (display target objects) identified as the objects to be displayed in step S709 from the 3D media file. This processing is processing for extracting, from the 3D media file, data necessary for displaying objects for a respective frame.

In step S711, the CPU 102 decodes the encoded data extracted from the 3D media file in step S710 to obtain 3D data and generates (renders) an image of display target objects based on that 3D data.

In step S712, the CPU 102 determines whether processing has been completed for all the frames included in the 3D media file. As a result of this determination, if processing has been completed for all the frames, the processing according to the flowchart of FIG. 7 ends. Meanwhile, if there is a frame for which processing has not yet been completed, the processing proceeds to step S713.

In step S713, the CPU 102 determines whether the priority levels of objects dynamically change based on a result of the analysis in step S702. As a result of this determination, if the priority levels of objects dynamically change, the processing proceeds to step S714, and if the priority levels of objects do not dynamically change, the processing proceeds to step S709. In step S714, the CPU 102 obtains the priority levels of objects in the next frame.

In the description thus far, generally a form in which information on the level of priority or the level of recommendation of an object and information related to a viewport is stored in a file has been described. However, information related to viewing does not necessarily need to be stored in a file. That is, information on the level of priority or the level of recommendation and information related to a viewport described with reference to FIG. 4, FIG. 6A, and FIG. 6B may be stored in a location different from a file storing the encoded data.

For example, metadata information associated with encoded data may be made into a file and associated in a system managed by software, or a form in which it is stored in a storage apparatus such as a RAM without being made into a file may be taken.

Such a form is suitable in large-scale systems in particular, and efficient centralized management becomes possible by storing priority level information associated with a viewport collectively rather than in individual files.

Incidentally, ISO/IEC 12113:2022 glTF 2.0 is known as a format for forwarding 3D content and for describing 3D scene information. Furthermore, in MPEG, ISO/IEC 23090-14 Scene Description, which is a technique that makes it possible to define, in 3D scene information, data encoded by a 3D encoding standard or audio encoding standard standardized by MPEG, is standardized by extending glTF 2.0. Therefore, the position information of an object and viewport information may be defined by applying a glTF 2.0 or Scene Description standard as 3D scene information. By using such standards for definition, they can be expected to be used in systems that support glTF 2.0.

In the description thus far, the level of priority and the level of recommendation, which are semantically similar terms, are used, but as described above, they are for indicating scales set for different intentions where the former is intended for what is generally prioritized, and the latter focuses on the intention of the content creator, and in the present embodiment, since it is not important which intention the scale is defined with, the two terms, the level of priority and the level of recommendation, may be construed to be synonymous.

Further, in the description thus far, a form in which a priority level is defined for each object or for each bounding box surrounding an object has been described. However, when a plurality of objects are in contact or a plurality of objects are entangled in a complex manner, for example, it may not be possible to clearly distinguish and define bounding boxes surrounding respective objects. Therefore, there are cases where a plurality of objects are included in one bounding box, for example. That is, cases where objects to be reproduced cannot be separated at the 3D data level are conceivable. Therefore, in such cases, it is desirable to assign an identifier to a “bounding box surrounding one or more objects” and set a priority level.

Further, by using a priority level for each object and a priority level for each bounding box surrounding an object, when reproducing, on a display terminal with low processing capability, content that places a high processing load and in which 3D data is used, for example, it is possible to display the content in order starting with the highest priority level within the range of the processing capability of the display terminal, and so, it is possible to reduce the load of rendering 3D data and perform reproduction processing without failure.

Furthermore, it is possible to perform display where, when viewed in a free viewpoint video, objects with a low priority level or objects that may interfere with viewing when viewed from a particular field of view are excluded. The objects with a low priority level are not simply hidden, and for example, only the wire frames of 3D objects may be displayed, and in a case of 3D data with scalability, such as Level of Detail (LoD), the level of detail for display is controlled in accordance with the priority level, thereby making it possible to favorably perform the rendering processing and reduce the processing load. Further, a usage method in which the priority levels of objects to be rendered are controlled in accordance with user privilege to view 3D data is conceivable.

Further, various definitions can be applied to the level of recommendation and recommendation/non-recommendation, which appear in the present embodiment. For example, the level of recommendation may be a parameter that assumes an integer value from 0 (lowest level of recommendation) to 100 (highest level of recommendation). Further, a level of recommendation that is greater than or equal to a threshold may represent “recommended”, and a level of recommendation that is less than the threshold may represent “not recommended”. Further, the level of recommendation may be represented using binary values, “0” and “1”, where the level of recommendation “0” represents “not recommended” and the level of recommendation “1” represents “recommended”.

When high-quality 3D data that includes a plurality of people is rendered on a device, such as a head-mounted display, a smartphone, or a tablet PC, to view the 3D data as a free-viewpoint video on the device, demanding requirements are placed on hardware resources, such as a CPU and a memory. Therefore, a service called cloud rendering in which computing apparatuses on the cloud perform rendering is also emerging. However, since, in cloud rendering, data such as a viewpoint, a viewing direction, and a viewing angle, is transmitted from each viewing terminal and a two-dimensional image is transmitted as a rendering result to each viewing terminal, transmission delay may become a problem depending on the communication environment and use case. Furthermore, when there are many viewing terminals that use cloud rendering, an increase in the load on computing apparatuses on the cloud side may become a problem. By using the information processing apparatus according to the present embodiment, it is possible to realize favorable rendering and reduce the rendering load.

### Second Embodiment

In the first embodiment, a case where the 3D media file generation processing and the 3D media file-based object reproduction processing are performed by the information processing apparatus 100 has been described, but these processes may be performed by using a plurality of computer apparatuses. A part of these processes may be executed by an external apparatus (e.g., a cloud server), and subsequent processes may be performed by the information processing apparatus 100 based on a result of the execution. Thus, the performer of the above overall processing and the configuration of the system therefor are not limited to a specific form.

Further, a computer program stored in the information processing apparatus 100 may be downloaded to the non-volatile memory 113 from a homepage on the Internet by connecting thereto from a browser of the information processing apparatus 100 serving as a client computer. The computer program may be an uncompressed computer program file, or may be a compressed computer program file with an automatic installation function.

Further, program code constituting the computer program may be divided into a plurality of files, and each file may be downloaded to the information processing apparatus 100 from a different homepage. That is, a WWW server from which a plurality of users download a file of a computer program for implementing the above processing in the information processing apparatus 100 may also be considered as an embodiment.

Further, it is possible to distribute such a computer program to users by encrypting it and storing it in a storage medium such as a CD-ROM and allow users who have met predetermined conditions to download key information for decryption from a homepage via the Internet. That is, the users can install the encrypted computer program on the information processing apparatus 100 by executing it in the information processing apparatus 100 using the key information.

The numerical values, processing timing, processing order, processing performer, data (information) configuration/obtainment method/transmission destination/transmission source/storage location, and the like used in the above embodiments have been given as examples for the sake of providing a concrete explanation, and the present invention is not intended to be limited to such examples.

Further, some or all of the embodiments described above may be appropriately combined and used. Further, some or all of the embodiments described above may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-150877, filed Sep. 2, 2024, and Japanese Patent Application No. 2025-078880, filed May 9, 2025, which are hereby incorporated by reference herein in their entirety.

What is claimed is:

1. An information processing apparatus comprising:
a storage control unit configured to cause a memory to store the three-dimensional data and metadata corresponding to the three-dimensional data in a file in a predefined format,
the storage control unit causing the memory to store, in the file, a priority level to display, for each object included in the three-dimensional data, or for at least some of those objects.

2. The information processing apparatus according to claim 1, wherein
the storage control unit causes the memory to store, in the file, viewport information, which includes a viewpoint, a gaze direction, and a viewing angle in a space that is based on the three-dimensional data.

3. The information processing apparatus according to claim 2, wherein
the storage control unit causes the memory to store, in the file, each of a plurality of pieces of the viewport information as a different track.

4. The information processing apparatus according to claim 1, wherein
the storage control unit sets, as a target, each object included in the three-dimensional data, or at least some of those objects, and causes the memory to store, in the file, information by which a target recommended for display can be identified from among those targets.

5. The information processing apparatus according to claim 1, wherein
the storage control unit sets, as a target, each object included in the three-dimensional data, or at least some of those objects, and causes the memory to store, in the file, information by which a target not recommended for display can be identified from among those targets.

6. The information processing apparatus according to claim 1, wherein
the priority level is either a level of priority, or a level of recommendation set in accordance with a level of importance of content.

7. An information processing apparatus comprising:
an obtaining unit configured to obtain, from a file in which three-dimensional data and metadata corresponding to the three-dimensional data are stored in a predefined format, a priority level to display, which is stored for each object included in the three-dimensional data, or for at least some of those objects; and
a control unit configured to control reproduction of the three-dimensional data based on the priority level.

8. The information processing apparatus according to claim 7, wherein
a display target object can be obtained as a divided object, which is one of a plurality of regions obtained by division,
the priority level is set for each divided object and is applied when reproducing the display target object from a predetermined viewport, and
in the control, a divided object that is positioned in a region necessary for displaying the display target object in a predetermined viewport is identified from a priority level of each obtained divided object, and
in the obtainment, the identified divided object is obtained.

9. The information processing apparatus according to claim 8, wherein
the priority level includes information intended to recommend display and information intended to not recommend display.

10. The information processing apparatus according to claim 7, wherein
the obtaining unit obtains, from the file, viewport information, which includes a viewpoint, a gaze direction, and a viewing angle in a space that is based on the three-dimensional data, and
the control unit controls the reproduction based on the viewport information and the priority level, which is associated with the viewport information.

11. The information processing apparatus according to claim 10, wherein
the obtaining unit obtains, from the file, viewport information with a highest level of recommendation among a plurality of pieces of the viewport information.

12. The information processing apparatus according to claim 7, wherein
information by which a target recommended for display can be identified from among respective objects included in the three-dimensional data, or from among at least some of the respective objects, is stored in the file.

13. The information processing apparatus according to claim 7, wherein
information by which a target not recommended for display can be identified from among respective objects included in the three-dimensional data, or from among at least some of the respective objects, is stored in the file.

14. The information processing apparatus according to claim 7, wherein
the priority level is either a level of priority, or a level of recommendation set in accordance with a level of importance of content.

15. The information processing apparatus according to claim 4, wherein
the storage control unit causes the memory to store, in the file, each object included in the three-dimensional data as a different track.

16. The information processing apparatus according to claim 1, further comprising:
an encoding unit configured to encode the object by using a predetermined encoding method, the encoding unit dividing the object into a plurality of regions, and encodes each region as a divided object so as to be independently decodable, and
the storage control unit sets the priority level to at least some of the plurality of encoded objects.

17. The information processing apparatus according to claim 2, further comprising:
an encoding unit configured to encode an object by using a predetermined encoding method,
the encoding unit divides the object into a plurality of regions, and encodes each region as a divided object so as to be independently decodable, and
the storage control unit sets a priority level that recommends obtainment for an encoded object positioned in a region necessary for display from the viewport information, and sets a priority level that does not recommend obtainment, or does not set a priority level, for an encoded object positioned in an occlusion region of the viewport information, among a plurality of encoded objects.

18. The information processing apparatus according to claim 7, wherein
the obtaining unit obtains a track in which predetermined viewport information is stored among a plurality of track, each storing a respective one of a plurality of pieces of viewport information as a different track, and
the control unit selects a display target object in accordance with a priority level associated with the viewport information.

19. An information processing apparatus configured to generate metadata corresponding to three-dimensional data, the information processing apparatus comprising:
an obtaining unit configured to obtain three-dimensional data,
the three-dimensional data obtained by the obtaining unit including a plurality of objects; and
a setting unit configured to set a priority level to display, for each of the objects included in the three-dimensional data, or for at least some of the objects,
the set priority level being generated as metadata.

20. A non-transitory computer-readable storage medium storing instructions of a computer program for causing a computer to function as each unit of the information processing apparatus according to claim 1.
